(19) United States
(12) Patent Application Publication
(10) Pub. No.: US 2015/0316173 A1
(43) Pub. Date: Nov. 5, 2015

(54) APPARATUS FOR ADJUSTING RELATIVE SPACING OF SECTIONS OF PIPE ARRANGED IN END TO END RELATION

(71) Applicant: 0961559 BC Ltd., Kelowna (CA)

(72) Inventor: Kevin Adams, Kelowna (CA)

(21) Appl. No.: 14/473,269

(22) Filed: Aug. 29, 2014

(30) Foreign Application Priority Data
Apr. 30, 2014 (CA) 2850647

(51) Int. Cl. F16L 1/09

(52) U.S. Cl. CPC F16L 1/09

(57) ABSTRACT

An apparatus for adjusting relative spacing of sections of pipe arranged in end-to-end relation. The apparatus includes a first saddle and a second saddle. Each saddle has a body with an underlying pipe receiving channel extending across a bottom between a first end and a second end. An upstanding actuator anchor extends upwardly from a top of the body. Overlying anchor chain receiving channels extend over the top of the body between the opposed sides. An actuator is connected between the respective actuator anchors to pull the first saddle and the second saddle toward each other.

### FIELD

There is described an apparatus used to adjust the relative spacing between sections of pipe that are arranged in end-to-end relation.

### BACKGROUND

Various utilities use sections of pipe welded in end-to-end relation to form pipeline networks. The larger the diameter of pipe, the more difficult it is to adjust the relative spacing between the sections of pipe.

### SUMMARY

There is provided an apparatus for adjusting relative spacing of sections of pipe arranged in end-to-end relation. The apparatus includes a first saddle and a second saddle. Each saddle has a body with a top, a bottom, a first end, a second end and opposed sides. An underlying pipe receiving channel extends across the bottom of the body between the first end and the second end. An upstanding actuator anchor extends upwardly from the top of the body between the first end and the second end. At least one overlying anchor chain receiving channel extends over the top of the body between the opposed sides and is positioned between the actuator anchor and the first end. At least one overlying anchor chain receiving channel extends over the top of the body between the opposed sides and is positioned between the actuator anchor and the second end. An actuator is provided having a first connection and a second connection. The first connection is connected to the actuator anchor of the first saddle. The second connection is connected to the actuator anchor of the second saddle. The actuator is capable of providing a pulling force to pull the first saddle and the second saddle toward each other.

When in use, the first saddle is placed on top of a first pipe at one end and secured in position by anchor chains that are received in the anchor chain receiving channels and the and the second saddle is placed on top of a second pipe at one end and secured in position by anchor chains that are received in the anchor chain receiving channels. The actuator is connected to the first connection of the first saddle and the second connection of the second channel. The actuator is then activated to pull the first saddle and the second saddle toward each other.

It is preferred that the actuator, in addition to providing a pulling force, be capable of providing a pushing force to push the first saddle and the second saddle away from each other. While, in a majority of applications, the apparatus will be used to pull pipes together, there are some applications in which the pipes must be pushed apart to increase the relative spacing.

Although the actuator could be hydraulic or take a number of other forms, beneficial results have been obtained through the use of a mechanical actuator. The mechanical actuator used has been a form of screw jack, with ratchet.

Although the actuator could be used with single anchor chain receiving channels on each side of the actuator anchor, beneficial results have been obtained through the use of two anchor chain receiving channels on each side of the actuator anchor and that is the preferred configuration.

The preferred form of pipe receiving channel is an inverted V groove. The reason for this is that it can more readily accommodate different diameter of pipe. To further increase the range of pipe that can be accommodate, it is also possible to have a nested V groove configuration in which a smaller inverted V groove is nested within the inverted V groove. The inverted V groove accommodates a range of diameter pipe and the small inverted V groove accommodates engagement teeth.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a side elevation view of apparatus on 2-inch diameter pipe.

FIG. 2 is an end elevation view of the apparatus illustrated in FIG. 1.

FIG. 3 is a side elevation view of apparatus on 20-inch diameter pipe.

FIG. 4 is an end elevation view of the apparatus illustrated in FIG. 3.

FIG. 5 is a side elevation view of saddle component for the apparatus illustrated in FIGS. 1-4.

FIG. 6 is an end elevation views of the saddle component illustrated in FIG. 5.

FIG. 7 is a top plan view of the saddle component illustrated in FIG. 5.

FIG. 8 is a side elevation view of the apparatus illustrated in FIG. 1 through FIG. 4, showing anchor chain positioning.

### DETAILED DESCRIPTION

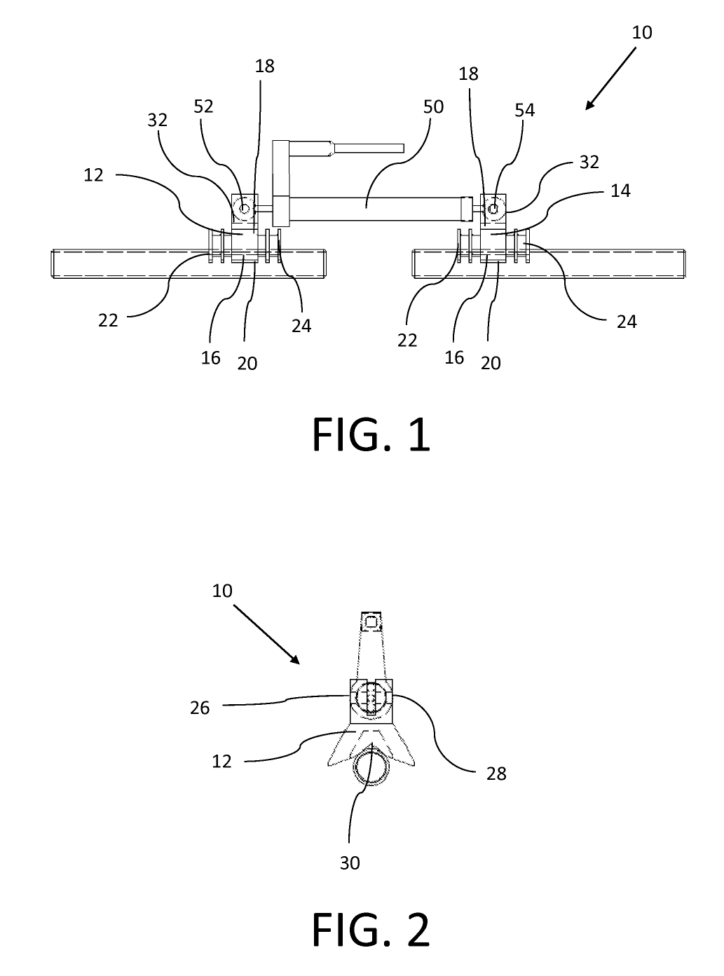

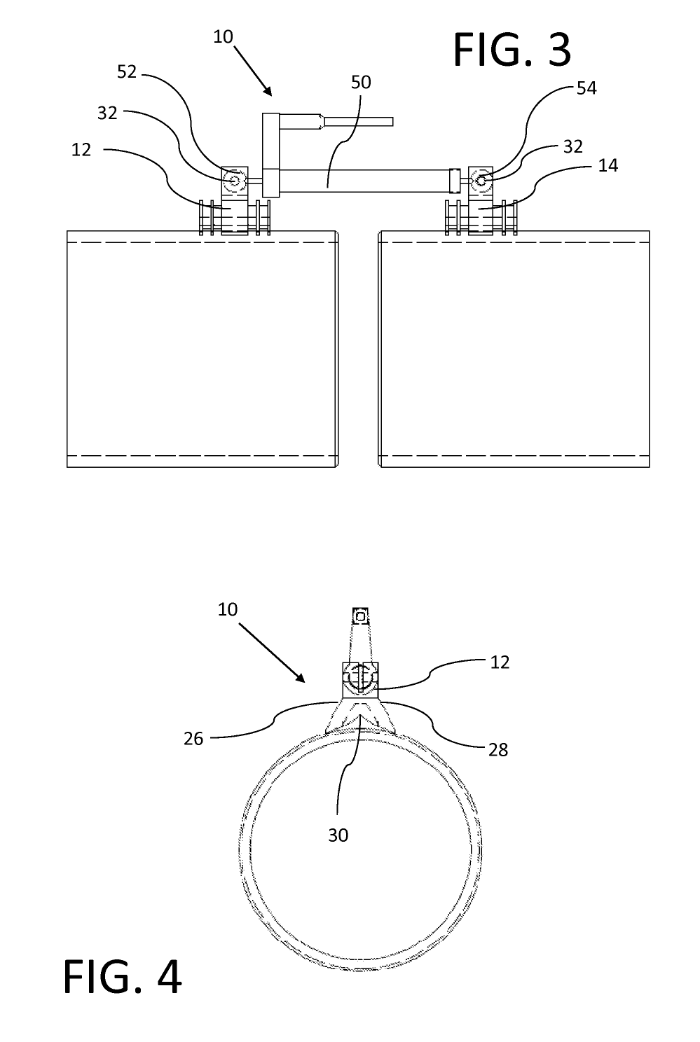

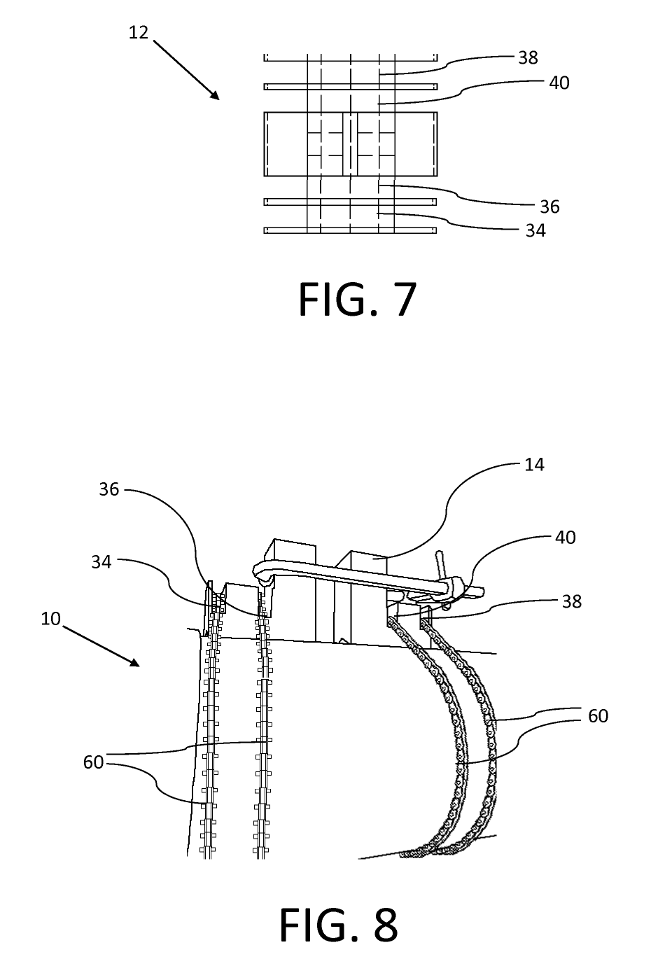

An apparatus for adjusting relative spacing of sections of pipe arranged in end-to-end relation, generally identified by reference numeral 10, will now be described with reference to FIGS. 1-8. It will be appreciated that one of the sections of pipe arranged in end-to-end relation may be a fitting, an elbow or a tee.

### Structure and Relationship of Parts

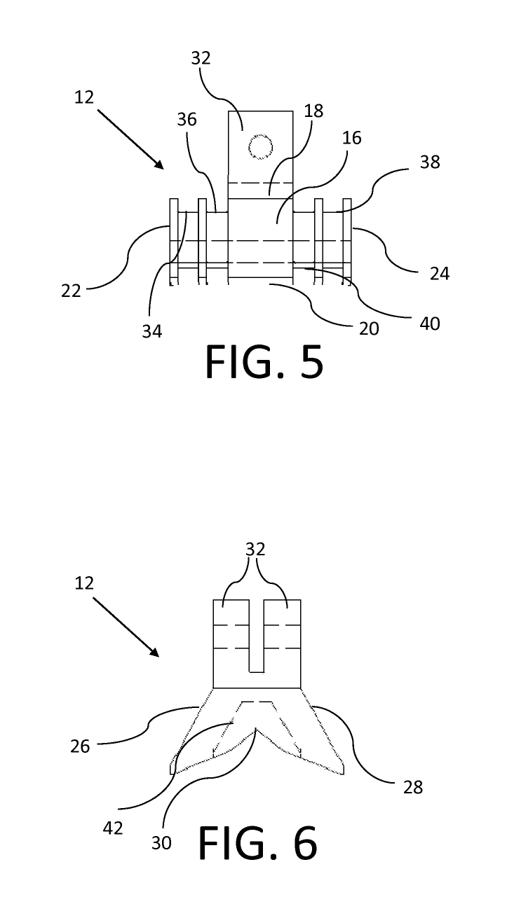

Referring to FIGS. 1-3, apparatus 10 includes a first saddle 12 and a second saddle 14. Referring to FIG. 5 through FIG. 7, each saddle has a body 16 with a top 18, a bottom 20, a first end 22, a second end 24 and opposed sides 26 and 28. An underlying pipe receiving channel 30 that extends across bottom 20 of body 16 between first end 22 and second end 24. An upstanding actuator anchor 32 extends upwardly from top 18 of body 16 between first end 22 and second end 24. Two overlying anchor chain receiving channels 34 and 36 extend over top 18 of body 16 between opposed sides 26 and 28. Chain receiving channels 34 and 36 are positioned between actuator anchor 32 and first end 22. Two overlying anchor chain receiving channels 38 and 40 extend over top 18 of body 16 between opposed sides 26 and 28. Chain receiving channels 38 and 40 are positioned between actuator anchor 32 and second end 24. It will be understood that while the depicted example shows two chain receiving channels 38 and 40, other numbers of chain receiving channels, such as 1 or 3 may be used. For example, when very large chain is used, it might be preferable to use 1 channel.

Body 16 is made from 6″×6″×6.5″ solid blocks of aluminium. The preferred form for underlying pipe receiving channel 30 is an inverted double V is machined in the bottom of the blocks, allowing for fit on a wide range of small and large pipe sizes. This V is machined along the 6.5″ length of the block. On top 18 of body 16, actuator anchor 32 is in the form of 3″ tall by 3″ long ears are machined in the center of the block (in line with the V groove), forming an upside down T shape. A ¾-in cut-out is then machined in the center of the ears to serve as an actuator connection that will accommodate the ratchet jack eye bolt. A hole is then bored through both V-block ears to accommodate ratchet jack pinning On either side of actuator anchor 32, two slots are machined, for a total of four slots per V-block jaw, which serve as chain receiving channels 34, 36, 38, and 40 to accommodate the appropriate number of chain clamps. These slots need to be made in such a manner as to facilitate the quickest possible transition from jaw to pipe contact to eliminate as much loss of friction as possible. An optional final process is the machining of slots 42 in the double V design to accommodate the insertion of carbide teeth or knurled teeth, in order to increase friction forces required to accommodate our desired push/pulling forces. As will be understood, the carbide teeth or knurled teeth need not be included on apparatus 10, and may only be included in some embodiments.

Referring to FIGS. 1-4, actuator 50 has a first connection 52 and a second connection 54. First connection 52 is connected to actuator anchor 32 of first saddle 12. Second connection 54 is connected to actuator anchor 32 of second saddle 14. Actuator 50 must be capable of providing a pulling force to pull first saddle 12 and second saddle 14 toward each other. It is preferred that actuator 50 also be able to provide a pushing action.

For actuator 50, we are using a simple loadbinder for the mechanical push/pull action we require. There is an endless variety of options available from mechanical to hydraulic, but the loadbinder is readily available and serves our purpose. The only alteration needed is the removal of hooks and links from the threaded eyebolts, allowing the threaded eyebolts to fit between the actuator anchor 32 ears; but this can be readily changed out with a variety of other options, both mechanical and hydraulic.

Referring to FIG. 8, for anchor chains 60 we are using Irwin Locking Chain Clamps. They allow us to add an unlimited number of Irwin chain extensions to accommodate any size of pipe. There are a variety of options but our basic principal on this unit is to generate enough clamping force, (increasing friction) from the chains, to accommodate the required lateral forces. Multiple clamps may have to be used with the chain receiving channels 34, 36, 38, and 40, wherein this is determined by the push/pull force desired.

### Operation

The step-by-step operation to use apparatus 10 is as follows:

1) Referring to FIGS. 1-4, place first saddle 12 and second saddle 14 on opposing pipe ends.

2) With the use of locking chain clamps serving as anchor chains 60, wrap pipe with chain placed in appropriate chain slots 34, 36, 38 and 40 and fasten locking chain clamps as tight as possible to ensure a strong grip on the pipe. As the diameter and mass of the pipe increases, the positioning of anchor chains 60 becomes more important. Selection of chain slots is determined by either push or pull movement. Multiple chains are required on leveraged side of movement:

Pulling Movement: two chains on outside of chain slots, one chain on inside chain slot.

Pushing Movement: two chains on inside of chain slots, one chain on outside chain slot.

3) The push/pull movement is then simply accomplished by the up and down handle motion on actuator 50. The direction of movement (push or pull) is determined by the jack pawl, located at the base of the jack handle. The back a forth pawl movement changes jack direction (push or pull). Select desired direction/movement and pull the handle back and forth to operate.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The scope of the claims should not be limited by the illustrated embodiments set forth as examples, but should be given the broadest interpretation consistent with a purposive construction of the claims in view of the description as a whole.

What is claimed is:

1. An apparatus for adjusting relative spacing of sections of pipe arranged in end-to-end relation, comprising:
a first saddle and a second saddle, each saddle having a body with a top, a bottom, a first end, a second end and opposed sides, an underlying pipe receiving channel that extends across the bottom of the body between the first end and the second end, an upstanding actuator anchor extending upwardly from the top of the body between the first end and the second end, at least one overlying anchor chain receiving channel extending over the top of the body between the opposed sides and positioned between the actuator anchor and the first end, and at least one overlying anchor chain receiving channel extending over the top of the body between the opposed sides and positioned between the actuator anchor and the second end; and
an actuator having a first connection and a second connection, the first connection being connected to the actuator anchor of the first saddle, the second connection being connected to the actuator anchor of the second saddle, the actuator being capable of providing a pulling force to pull the first saddle and the second saddle toward each other.

2. The apparatus of claim 1, wherein the actuator, in addition to providing a pulling force, is capable of providing a pushing force to push the first saddle and the second saddle away from each other.

3. The apparatus of claim 1, wherein the actuator is a mechanical actuator.

4. The apparatus of claim 1, wherein there are two anchor chain receiving channels on each side of the actuator anchor.

5. The apparatus of claim 1, wherein the pipe receiving channel is an inverted V groove that accommodates pipe having a range of differing diameters.

6. The apparatus of claim 1, wherein a smaller inverted V groove is nested within the inverted V to accommodate engagement teeth.
